(19) United States
(12) Patent Application Publication
(10) Pub. No.: US 2008/0249791 A1
(43) Pub. Date: Oct. 9, 2008

(54) System and Method to Document and Communicate On-Site Activity

(76) Inventor: Vaidy Iyer, Tempe, AZ (US)

Correspondence Address: MUSKIN & CUSICK LLC, 30 Vine Street, SUITE 6, Lansdale, PA, 19446, US

(21) Appl. No.: 11/738,510

(22) Filed: Apr. 22, 2007

Related U.S. Application Data
(63) Continuation-in-part of application No. 11/738,508, filed on Apr. 22, 2007.
(60) Provisional application No. 60/913,270, filed on Apr. 21, 2007.
(60) Provisional application No. 60/910,174, filed on Apr. 4, 2007.
(60) Provisional application No. 60/912,101, filed on Apr. 16, 2007.

(51) Int. Cl. G06Q 99/00

(52) U.S. Cl. 705/1

(57) ABSTRACT

A system to assist plant maintenance and inspection using an enterprise system and automatic notifications. A worker can generate a form related to maintenance or inspection of a piece of equipment, upon which automatic notifications can be transmitted to the relevant parties such as a technician. An automatic notification of the incident can also be sent as a pop up notification to particular person's computer.

### CROSS REFERENCE TO RELATED APPLICATIONS

This Application claims benefit to provisional application 60/913,270, which is incorporated by reference herein in its entirety. This application also claims benefit to provisional application 60/910,174, which is incorporated by reference herein in its entirety. This application also claims benefit to provisional application 60/912,101, which is also incorporated by reference herein in its entirety. This application is also a continuation in part of application Ser. No. 11/738,508, which is incorporated by reference herein in its entirety.

### FIELD OF THE INVENTION

The inventive concept relates to the field of computer applications. Specifically, the inventive concept relates to a mobile system for transmitting inspection and maintenance information.

### BACKGROUND OF THE INVENTION

When a factory is undergoing an inspection, a factory worked may use a notepad or a portable computer (such as a laptop) to record occurrences such as malfunctions, inspection results, or requests for repair.

What is needed is an improved way to document such occurrences and an improved way to notify additional appropriate personnel of any such activities.

### SUMMARY OF THE INVENTION

It is an aspect of the inventive concept to implement improvements in plant activity notifications.

The above aspect(s) can be obtained by a method that includes (a) visually identifying, by an employee, an occurrence at the site; (b) entering data, by the employee, describing the occurrence on a portable computer; (c) electronically transmitting the data to an ERP application; (d) identifying a recipient of an alert based on business rules associated with the ERP application; and (e) transmitting the alert to the recipient.

The above aspect(s) can also be obtained by a method that includes (a) providing form data for a form by a plant worker on a portable computer; (b) transmitting the form from the portable computer to an ERP system; (c) generating, by the ERP system, a ticket based on form data; and (d) transmitting ticket data relating to the ticket to the plant worker.

The above aspect(s) can also be obtained by a system that includes (a) a server to receive form data from a portable computer; (b) an ERP application to receive the form data from the server and to generate a ticket request in the ERP application, wherein ticket data related to the ticket request is transmitted to the server, wherein the ticket data is transmitted to the portable computer.

### BRIEF DESCRIPTION OF THE DRAWINGS

Further features and advantages of the present inventive concept, as well as the structure and operation of various embodiments of the present inventive concept, will become apparent and more readily appreciated from the following description of the preferred embodiments, taken in conjunction with the accompanying drawings of which:

FIG. 1 is a block diagram illustrating data flow between components, according to an embodiment;

FIG. 2 is a block diagram illustrating components, according to an embodiment;

FIG. 3 is a flowchart illustrating a method to implement a process to record plant occurrences, according to an embodiment;

FIG. 4 is an exemplary pressure sensitive screen display for a tablet pc, according to an embodiment.

FIG. 5 is screen shot illustrating an exemplary ticket generated in the ERP system, according to an embodiment;

FIG. 6A is screen shot illustrating an exemplary line view of a factory, according to an embodiment;

FIG. 6B. is a screen shot illustrating an exemplary machine view, according to an embodiment;

FIG. 7 is a screen shot illustrating various notifications, according to an embodiment;

FIG. 8 is an exemplary output on a portable pc of a form being entered, according to an embodiment; and

FIG. 9 is the form from FIG. 8 generated in a digital form, according to an embodiment.

### DETAILED DESCRIPTION

Reference will now be made in detail to the presently preferred embodiments of the inventive concept, examples of which are illustrated in the accompanying drawings, wherein like reference numerals refer to like elements throughout.

The present general inventive concept relates to a system and method for automatically implementing processing of occurrences that can occur in a workplace such as a factory, plant, office, or virtually any location. An occurrence is an activity or condition that can be documented, such as a malfunction, inspection request and/or inspection result, maintenance request, etc.

Enterprise resource planning (ERP) applications are applications that integrate (or attempt to integrate) data and processes of an organization into a unified system. A typical ERP system can use multiple components of computer software and hardware to achieve the integration. A key ingredient of most ERP systems is the use of a unified database to store data for the various system modules. One example of ERP application software is SAP. All of the features and embodiments described herein can be applied to any ERP software application, such as SAP.

A plant worker can walk around a plant using a tablet pc. The tablet pc can be connected to a plant server wireless through any known computer communication network (e.g., wifi, etc.) The plant worker can walk around and visually inspect assembly lines and other aspects of the plant.

The plant worker can also monitor assembly lines on his table pc using a tool such as a dashboard that can provide information on a screen about the plant (a plant dashboard). The plant worker may wish to focus on a particular assembly line, therefore the worker can click on a particular assembly line in the plant dashboard (or other method in accordance with a graphical user interface), to bring up a line dashboard. The line dashboard illustrates information about a particular assembly line, such as the current work pieces, current productions statistics, etc. All of the information displayed on the tablet pc can be garnered from server(s) running at the plant (or other location) which store the needed information.

The plant worker may have visually inspected a malfunction with a piece of equipment in the plant. The plant worker can bring up the piece of equipment on his tablet pc (by clicking the appropriate selections) and indicate (e.g., by clicking an appropriate box) that the piece of equipment has malfunctioned. The plant worker can select a particular type of form to fill out (e.g., maintenance request, inspection, etc.)

The form can then automatically be opened and relevant data from the equipment that the worker has identified (e.g., machine number, name, location, etc.) can automatically be filled into the form. The worker can then fill in remaining entries in the form by writing the entries in using the worker's own handwriting (or alternatively typing the entries).

Once the form is saved, then a PDF of form can be generated and stored on a plant server. Notifications can now be sent in numerous ways to numerous different parties. For example, a wireless message can be sent to a technician associated with the particular piece of equipment that malfunctioned (e.g., sent to his cell phone or PDA). A maintenance ticket can be generated in the plant's ERP system so that the maintenance ticket can be acted on in turn. An automatic desktop notification can be sent to a particular party's (e.g., a supervisor) desktop so that person is interrupted and notified of the matter.

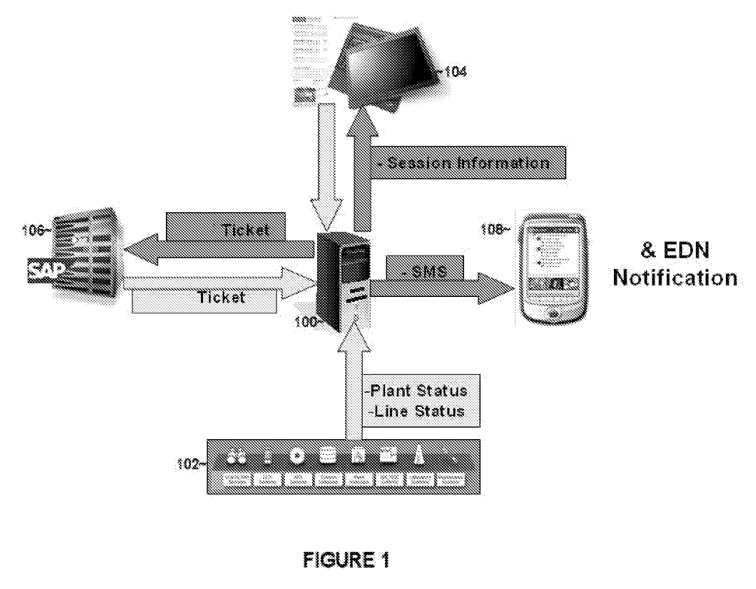

FIG. 1 is a block diagram illustrating data flow between components, according to an embodiment.

A server 100 can store and communicate with other components of the system. A factory monitoring system 102 is used to automatically monitor and transmit real time factory data, such as which machines are operation, power used, etc. This data can be transmitted to the server 100.

A tablet pc 104 is a portable computer used by plant worker(s) while they can walk freely around the plant. The tablet pc 104 can have a touch sensitive screen so that the plant worker can write with a pen on the screen which can then be automatically recognized and translated into text. The plant worker can also draw a drawing on the table pc 104 which would not be converted into text but would instead be converted to an image file (e.g., a JPG) and stored and transmitted in this format to the rest of the system. Session information 104 can be automatically transmitted from the server 100 to the tablet pc 104 so that when the plant worker opens up a form, part of the form can be automatically filled in using values that the server knows. For example, if the plant worker indicates he or she wishes to fill out a maintenance ticket regarding a particular machine, the server 100 can transmit any relevant information, such as the machine's name, ID #, type, etc., which can then automatically appear on the form on the table pc 104.

The server can then generate a maintenance (or any other type) of ticket, which can then be processed by an ERP application 106. The server 100 can actually be another SAP application called as xMII (manufacturing Integration and Intelligence). This application acts as the integration broker and re-directs the message from the Tablet to ERP. This is required because an ERP inherently does not support or can act as a Integration broker and one needs a separate application like xMII to handle various data formats. The ERP application can actually be any ERP or business related application that can track business process flows, inventory, maintenance, or any other business related information that can be processed and stored in a database.

The server 100 can send an instant wireless SMS or other type of instant message to a portable wireless device 108 such as a cell phone, PDA 108, etc., owned by a respective party, such as a technician responsible for the machine.

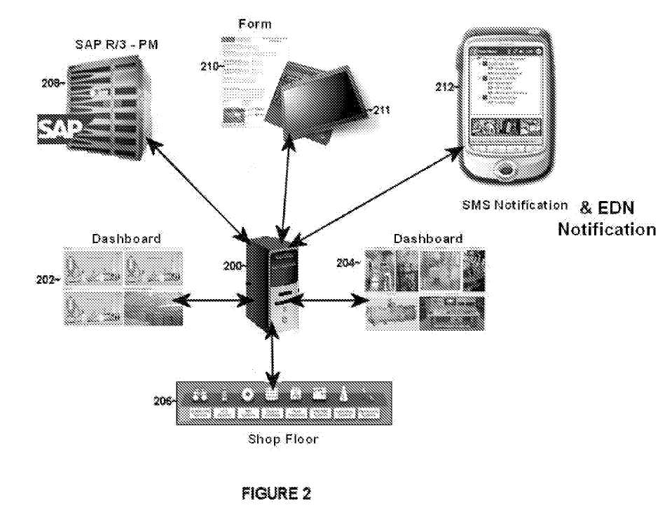

FIG. 2 is a block diagram illustrating components, according to an embodiment.

The server 200 is used to coordinate communications between the different components of the system. The server can receive data from the factory monitoring system 206, the data of which can be used to display different dashboard views 202 and 204 which can be displayed on any computer connected to the system, such as a tablet pc 211. The dashboard views conglomerate data from different machines in order to visually present that data in a intuitive manner.

The tablet pc 211 can display dashboard views of the factory data and allow a user of the tablet pc 211 to navigate such data. The tablet pc 211 can generate a form 210 which a user can fill in on the tablet pc using related to the equipment that related to the occurrence.

The SAP application 208 can be used to generate a ticket (e.g., “trouble ticket,” maintenance request, inspection request, etc.) which is then stored and may be placed in a queue so that it can be acted upon by the appropriate employees. A ticket is an entry in a database used by an ERP (such as an SAP system), that described a condition that needs action by company employees. Once the condition/occurrence is addressed appropriately (e.g., by fixing the machine, inspecting the machine, etc.) the respective ticket can be updated to reflect its new status. Each ticket is associated with a respective database record stored in the ERP system (or other server/storage) which stores information about the condition, such as a description of what happened, the machine involved, ticket number, plant worker ID that generated the ticket, etc.

The server 200 can also send an SMS notification to a portable device 212 used by a party associated with the equipment or event (according to rules stored by the ERP application 208). An EDN (enterprise desktop notification) can be transmitted to a computer used by a party associated with the equipment or event (according to rules stored by the ERP application). Each different piece of equipment in the plant and/or event concerning the equipment can have a notification list, of different employees and the manner in which they may receive an instant notification. For example, a technician assigned to a particular piece of equipment that malfunctions can be assigned to receive an instant wireless notification to his cell phone, while a plant supervisor may receive a notification to his desktop computer via a pop up screen (using a mini-application running on that computer). A system administrator can set rules in any manner the administrator sees fit so that the appropriate people receive notifications.

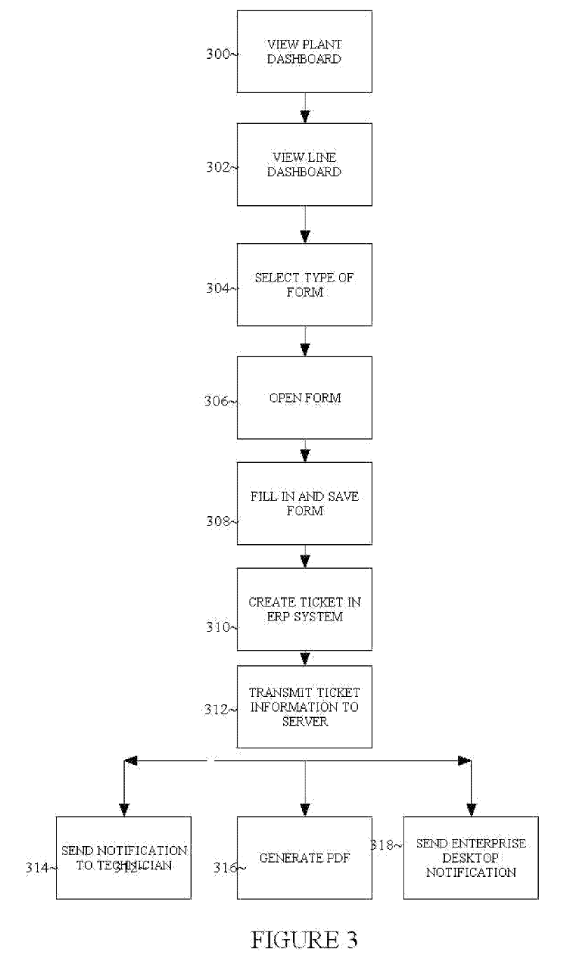

FIG. 3 is a flowchart illustrating a method to implement a process to record plant occurrences, according to an embodiment.

The method can start with operation 300, wherein a user/plant worker can view a plant dashboard on a computer such as a tablet pc (or any other type of computer such as a desktop). This can be done using an application that receives information (such as operating status, etc.) about different components and equipment used by the plant and tabulates the information in order to provide the plant worker with a high level visual view of the plant. The factory monitoring system 102, 206 can transmit data about the machines in the factory to a server, which then can transmit the data to the plant worker's portable pc in the form of a visual dashboard which allows the plant worker to select various views of the factory, assembly lines, machinery, and their respective status. The dashboard and related information can also be utilized on any other computer in the factory as well.

From operation 300, the method can proceed to operation 302, wherein the plant worker can manipulate the plant dashboard to bring up an assembly line dashboard, which is a more detailed view of the plant dashboard. The line dashboard can display representations of individual machines and optionally representations of articles of manufacture being constructed on that assembly line. On the assembly line dashboard, the plant worker can click individual machines and bring up an individual machine view which displays information about that particular machine, such as its model number, operating status, maintenance history, inspection history, etc.

Form operation 302, the method can proceed to operation 304, wherein the plant worker can select a type of form to fill out. If the plant worker has any type of report that he or she wishes to file with respect to the particular machine, the plant worker can indicate as such on his or her tablet pc. The planet worker can also indicate what type of report he or she wishes to file (e.g., inspection or maintenance, etc.), upon which the appropriate form will be brought up in the tablet pc.

From operation 304, the method can proceed to operation 306, which opens the form on the tablet pc. The appropriate template for the selected form is loaded on the tablet pc. Different forms can be stored locally on the tablet pc, or alternatively the forms can be stored on the server 100 or 200 and any forms needed by the tablet pc can be transmitted to the tablet pc. All transmissions between the tablet pc and the server 100 or 200 can be performed using any communications method such as wifi, etc. Certain fields are automatically filled in, such as the machine type, status, etc. The machine was identified to the system in operation 302, and the tablet pc can query the server 100 or 200 to determine the values that should be entered into particular fields in the form.

Form operation 306, the method can proceed to operation 308, wherein the plant worker fills in the form (at least fills in the fields that were not automatically filled out). The plant worker can either type in the values for the fields or write them using his or her own handwriting. The plant worker completes the form by supplying form data (or ticket request data) until the form is completed.

If the plant worker writes in his or her own handwriting, then automatic handwriting recognition can be applied to the handwriting to convert the handwriting to actual text characters (e.g., ASCII or other digital representation of letters). The conversion can be performed on the tablet pc itself, or an image of the handwriting can be transmitted to the server 100 or 200 (or other server) for conversion. If the plant worker wishes to draw an image, for example, of a broken machine, the plant worker can do so which will not get converted into text but will instead be saved and transmitted as an image file.

Once the plant worker is done filling out the form, the plant worker can then save the form. The completed form can then be transmitted back to the server 100 or 200. The completed form can come in many forms. For example, an image file (e.g., JPG or PDF) of the completed form can be transmitted and stored. An XML file (or other markup language) describing the form (containing the form data) can also be transmitted to the server 100 or 200. The XML file can have XML tags for fields in the form and their respective values (e.g., ‘<machine number=“123”>’), as known in the art. Any images drawn by the plant worker can be stored as a separate file and pointed to in the XML file (or alternatively the image data can be embedded in the XML file itself).

From operation 308, the method can proceed to operation 310, which creates a ticket in the ERP system (such as SAP) based on the occurrence that was the subject of the form that was filled out. The server 100 or 200 can communicate with the ERP system 106, 208, to transmit data from the form (which is a ticket request by the plant worker) The ERP system can then generate a ticket, which includes assigning ticket information to the ticket, e.g., ticket number, nature of request, place in queue, etc. The ERP system generates a list of tickets, which are matters that need to be addressed by plant or company employees. The tickets can be stored and resolved in a queue, or any other data structure. When a ticket is addressed by an employee and resolved, then the status of that particular ticket can be marked as resolved in the ERP application so unresolved tickets can be continued to be resolved.

From operation 310, the method can proceed to operation 312, which transmits ticket information from the ERP system to the server 100 or 200. The server 100 or 200 can then generate a web page (or other database entry) containing the ticket information. The web page link can then be transmitted back to the plant worker, so that the plant worker can visit the web page on his or her tablet pc in order to see a confirmation of his or her ticket request.

From operation 312, the method can also proceed to operation 314, which sends a notification of the occurrence to a technician associated with the machine that is the subject of the form filled out and/or the type of occurrence. More than one technician can also be notified of the occurrence, depending on notification rules stored in a server or in the ERP application. The notification can be accomplished in any manner, such as sending an instant message to a portable device (or desktop), making an automated cell phone call, etc.

From operation 312, the method can also proceed to operation 314, which generates a PDF (or other image file) of the completed form. The PDF document can be stored in the ERP application storage and/or the server 100 or 200, as well as on the tablet pc itself. The PDF document can be archived for long term storage and access.

From operation 312, the method can also proceed to operation 316, which sends an enterprise desktop notification to one or more recipient(s). The recipients are identified using business rules associated with the system. The recipients can receive the enterprise desktop notification as a pop up alert on their desktop. The recipient may have an opportunity to acknowledge the alert by clicking response buttons in the pop-up window, which then get transmitted back to the server and/or ERP application so further action may be taken based on the response.

For example, a plant worker may inspect a particular piece of machinery and notice that it may have a certain defect, but it is still operational. The plant worker may perform operations 300 to 308, wherein, wherein the ticket is generated. In operation 316, a notification of the defect is transmitted to a recipient, such as a manager. The notification may request that the manger take some action, for example, either allow the defective machine to continue operating or shut it down. The manager can be presented with buttons (e.g., “shut down,” “continue,”) on his output device which the manager may click one, upon which the respective button that the manager clicked can be transmitted back to the server and/or ERP application. Further action can then be taken based on the manger's decision. For example, if the manager selected to shut down the machine, then the machine can be shut down (either automatically or manually), or alternatively, if the manager selected that the machine continue operating then the machine can continue operating.

A list of occurrences and their respective recipients can be maintained, such as illustrated below in Table I.

TABLE I

| Occurrence | notify | via |
|---|---|---|
| Malfunction machine #123 | Joe Smith | SMS cell phone |
| Malfunction machine #123 | Bill Brown | mini-application, IP |
| | | 1.2.3.4 |
| Inspection needed any machine | Mick Jones | email |

Thus, for example, the rules in Table I can be applied when particular occurrences occur. For example, if a plant worker fills out a form to indicate that machine #123 has malfunctioned, then Joe smith will get an SMS message and Bill brown will get a desktop notification pop up. If an inspection is indicated to be needed by any machine, then Mick Jones (a technician) can be notified via email to inspect that machine.

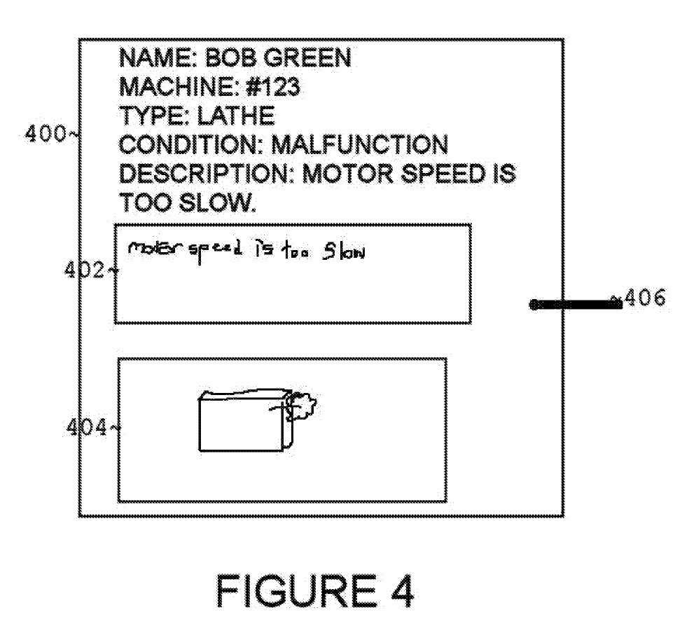

FIG. 4 is an exemplary pressure sensitive screen display for a tablet pc, according to an embodiment.

As described herein, a plant worker can use a tablet pc in order to fill out a digital form, which then can be converted to an image format such as JPG, or PDF format. When the plant worker selects a machine or equipment to fill out a form about (in operation 302), the table pc can automatically fill in some entries (it can query a server to receive information the server knows about the machine or equipment, e.g., the machine number and type). The plant worker can fill out some fields by writing in his own penmanship in a writing area 402 using a tablet pc pen 406, which is automatically recognized by the tablet pc and converted to text. The plant worker can also optionally draw a picture in a picture window 404 using the pen 406, which will be converted to image format and stored along with the form.

Instead of making his or her own drawing, the plant worker may also take a picture of the machine or related image using a cell phone (or other camera), which can then be transmitted to the tablet pc and then included in the form (instead of the drawing described herein).

Once the form is completed, it can be transmitted to the server for storage and further action, as described herein. The form can be transmitted in numerous ways: a complete image file, or typically in segments using a markup language such as XML which contain the data for each field along with image data for items such as the drawings.

The data from the form can be transmitted to the ERP application, which can then generate a ticket (a request for further action). A list of open tickets can be maintained in the ERP system and as employees resolve each ticket, a status of each ticket can be changed from open to closed.

After the plant worker completes the form and the form is transmitted to the ERP application, the tablet pc can then be directed to a particular web page. The particular web page can be served or associated with the ERP system and can display the ticket that the plant worker has just generated including a ticket number.

A further example of process flow of embodiments described herein will now be described. Referring back to FIG. 1, the factory monitoring system 102 sends factory status updates of all of its machinery to the server 100. Factory status can be any digital representation of machines in a factory/plant, such as which machines are operable or malfunctioning, power used, line status, oil pressure, etc. A plant worker using a tablet pc 104 (or any other type of pc, may or may not be portable, may have wireless communication capability to communicate wirelessly with the server 100 and any other component described herein) views factory status on his tablet pc 104 using the factory status information that is transmitted from the server 100 to the tablet pc 104.

The plant worker then wishes to initiate a maintenance or inspection ticket (or any other type of ticket or report), so the plant worker presses appropriate buttons on the tablet pc 104 to identify a particular machine the plant worker wishes to generate the report about. The plant worker will view real time status information about the particular machine on his tablet pc 104. A form will open in the tablet pc 104 and certain fields can automatically be filled in (since the tablet pc 104 receives information from the factory monitoring system 102 through the server 100). The plant worker will then use the tablet pc 104 to enter any additional information about the particular machine (e.g., oil drip, etc.), and possibly draw or take a picture of the particular machine to create a completed form, and the completed form is transmitted to the server 100.

The server 100 then transmits text from the completed form to the ERP application 106 which generates a ticket using the text. A PDF of the form can be saved on the server 100. The ticket is then addressed using the ERP application 106, such as putting it in a queue and possibly assignment employees to address the issues which were the cause of the creation of the ticket (e.g., a machine malfunction, oil drip, etc.) The ERP application 106 also generates a ticket number and any other information needed about the ticket.

The ERP system then transmits the ticket information to the server 100 which then can set up a web page for the ticket. The web page may be a private web page so that only authorized personnel can view the web page. The web page is then sent to the tablet pc 104 which then visits the web page so that the plant worker can see the web page generated which illustrates the newly created ticket.

The server 100 can also send messages to the appropriate personnel. A notification can be sent to a respective technician's cell phone (e.g., Blackberry) or other portable device. The server 100 can also send a notification can be sent to another party's desktop computer using a gadget (e.g., Google gadget) so that party will receive an instant notification about the ticket. The server 100 can also store and archive the PDF file of the completed form generated by the plant worker using his or her tablet pc 104, and the PDF file can also be associated with the ticket.

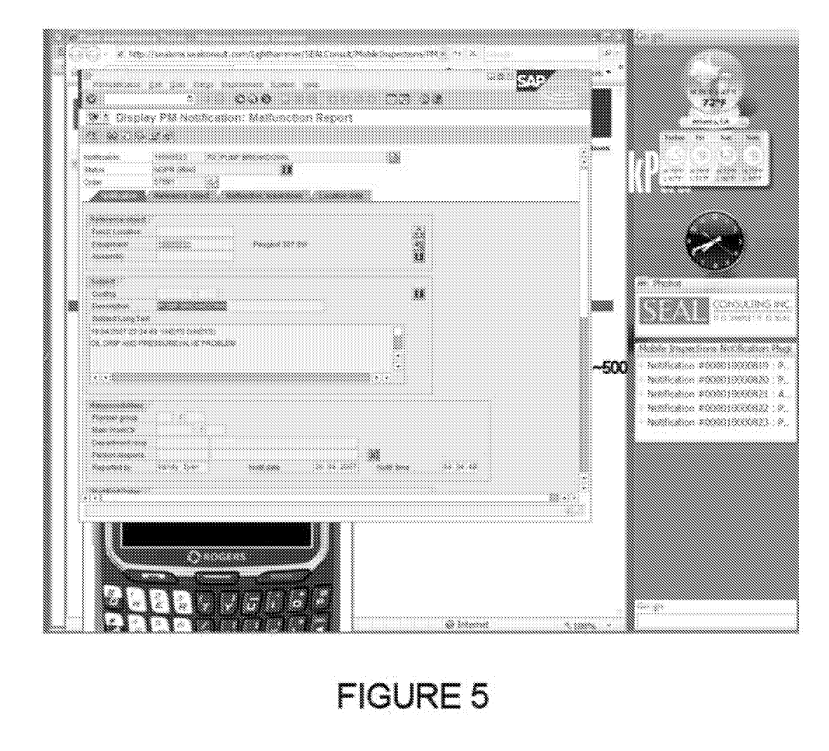

FIG. 5 is screen shot illustrating an exemplary ticket generated in the ERP system, according to an embodiment.

An SAP display window 500 shows the ticket information that was generated in the SAP system.

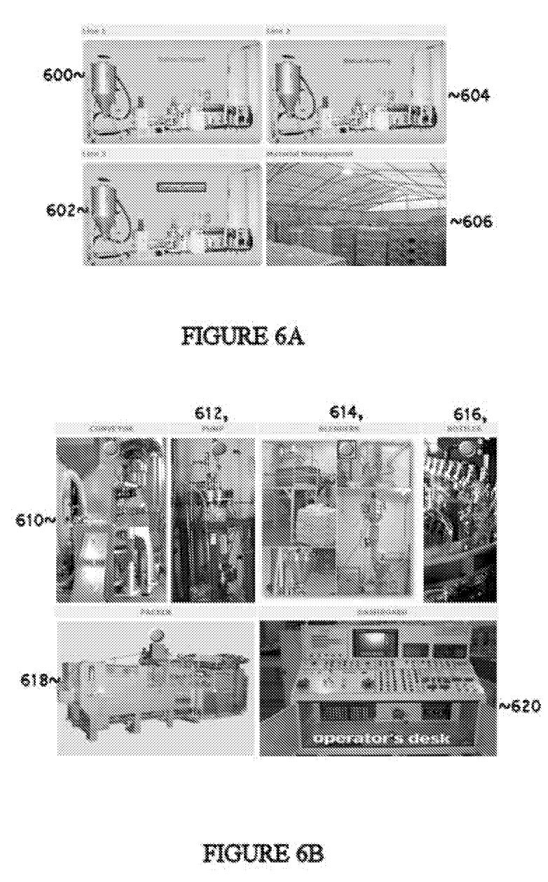

FIG. 6A is screen shot illustrating an exemplary line view of a factory, according to an embodiment. This is a type of dashboard view.

A first assembly line view 600, a second assembly line view 602, a third assembly line view 604, and a factory view 606 are displayed. These views can be displayed on any computer in the factory, such as on the plant worker's tablet pc, or any desktop therein.

FIG. 6B. is a screen shot illustrating an exemplary machine view, according to an embodiment. This is a type of dashboard view. The plant worker can select which assembly line view from FIG. 6A he or she wishes to expand upon, and that respective assembly can be illustrated in more detail showing each individual machine and its current status (operation, malfunction, etc.)

A first machine 610, a second machine 612, a third machine 614, a fourth machine 616, a fifth machine 618, and an operator's desk 620 are shown. Each machine has a button on top of it indicating the machine's status (e.g., green for operational, red for not operating). All of the machines have a green button but for the second button, which is red to indicate that machine is not functioning. The plant worker can further select one of these machines in order to generate a ticket regarding it. In this case, for example, the plant worker may select the second machine, which is not functioning, so the plant worker can generate a maintenance/repair ticket.

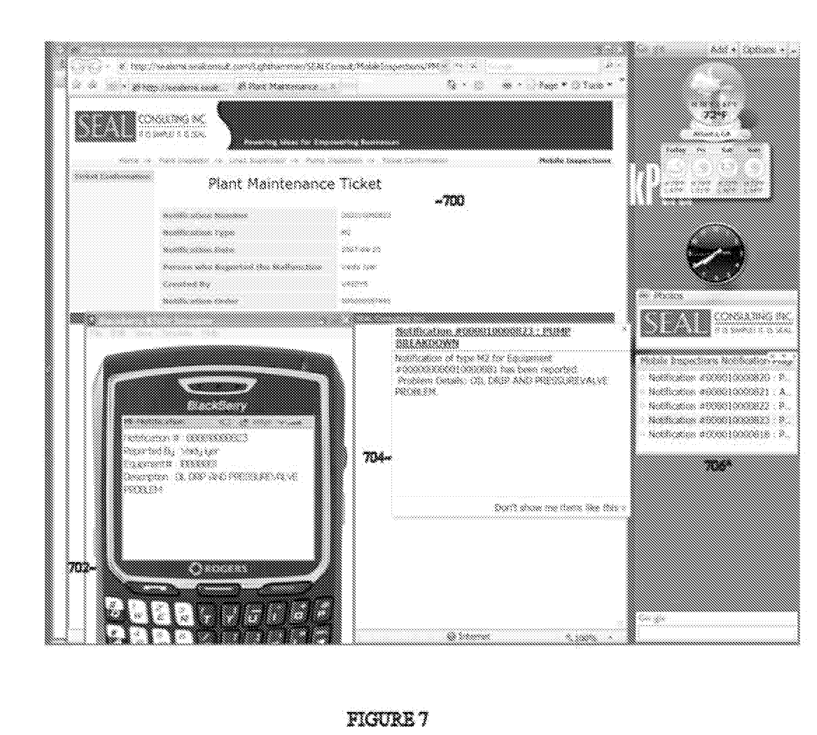

FIG. 7 is a screen shot illustrating various notifications, according to an embodiment.

A plant maintenance ticket 700 can be displayed, for example on the portable computer that was used to fill out the form in which the ticket was based on in the first place. The maintenance ticket can display information such as the ticket (or notification) number, ticket (or notification) type, ticket (or notification) date, person who initiated the ticket, and any other related information (ticket data).

A portable wireless device (such as a Blackberry 702) can receive and display an instant notification relating to a new event or occurrence, e.g., “notification #1234, reported by John Doe, equipment #1987, description, “Oil Drip and Pressure Valve Problem.” A pop up window 704 can also pop up on a user's computer (the user selected according to business rules store in association with notifications). The text in the pop up window 704 can display data related to the new event or occurrence, such as the data displayed on portable device 702. A list of notifications 706 can also be available on a user's desktop, whereby the user can click an individual notification to bring up that notification. In this manner, old notifications can all be stored and accessed by the user.

Once a ticket is generated, it can be transmitted to appropriate parties in numerous ways. A web page can be generated with the ticket information, so anyone at the factory can visit the url of the web page to view the ticket information. The plant worker that originally generated the ticket can receive the url from the server once the ticket is generated so that the plant worker can see a confirmation of his or her ticket request and any relevant ticket information. The plant worker can periodically visit this web page in order to check on the status of the ticket, for example to see where it is in the queue, whether it has been resolved, etc. Each ticket can have a status, such as open or closed. Once a ticket has been addressed, the ticket's status can change from open to closed.

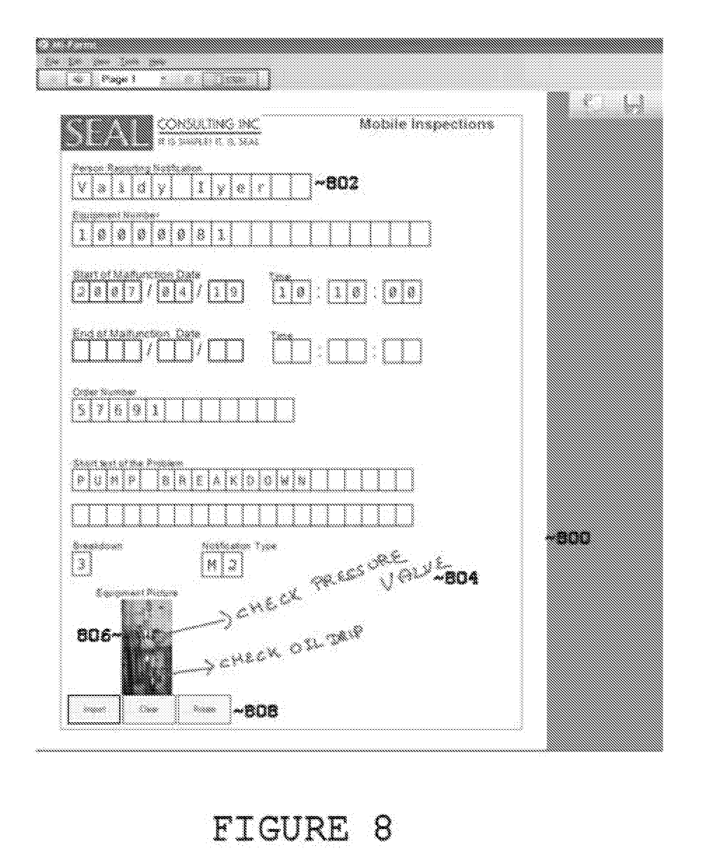

FIG. 8 is an exemplary output on a portable pc of a form being entered, according to an embodiment.

When the plant worker is generating the form (see operation 308), a form 800 will appear on the output device the plant worker is using. The form has text boxes 802 which allows the plant worker to enter in data, either by using handwriting recognition or by typing in answers in a keyboard. The plant worker can also write in comments 804. A form image 806 can be drawn by the plant worker or else photographed by the plant worker (e.g., by using a camera phone), or the image can be supplied by video cameras in the factory. Buttons 808 in the digital representation of the form allow the plant worker to manipulate the form, such as selecting the form image or sending the form once the form is completed by the plant worker.

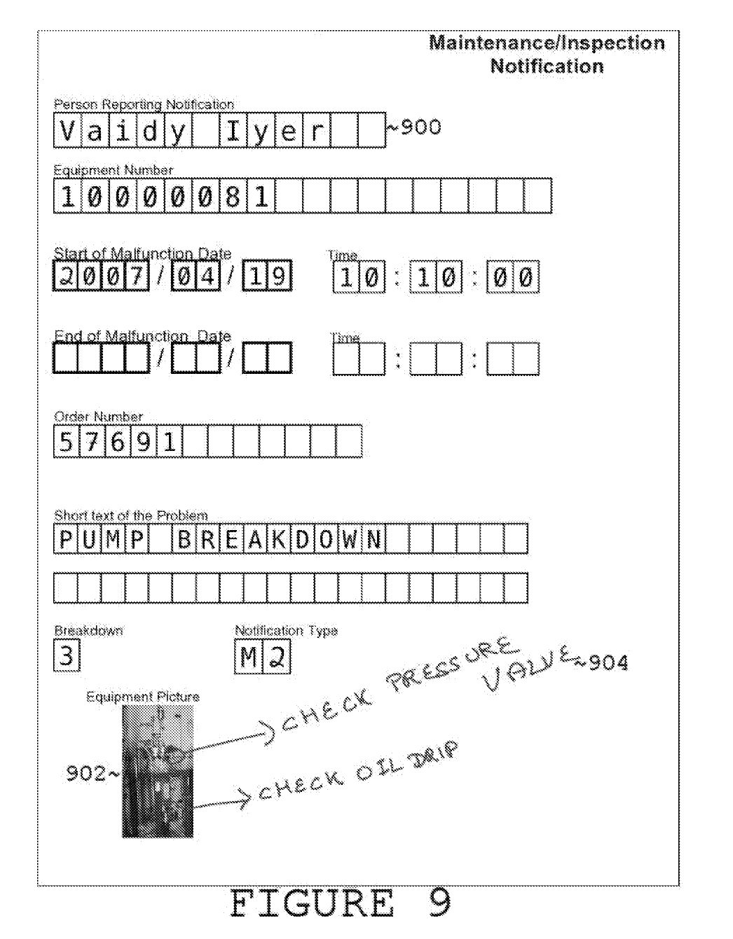

FIG. 9 is the final form from FIG. 8 generated in a digital form, according to an embodiment.

The text boxes 900 are all filled in permanently, and the final form also contains an optional image 902 and plant worker comments 904.

The present methods described herein can be implemented any type of known digital computer technology. Programs for implementing these methods can be stored on a computer readable storage medium, such as a DVD or CD-ROM, etc. All components mentioned herein can communicate each other using a computer communications network (e.g., a LAN or Internet) or wirelessly (e.g., wifi). It is noted that all applications and/or software programs described herein can run on any number of servers (e.g., they can all run on the same server or multiple servers.) For example, server 100 and the ERP application 106 can both run on the same server, can run on two different servers in communication with each other, or can even run different processes and modules on more than two servers.

Although the inventive concept has been described in terms of exemplary embodiments, it is not limited thereto. Rather, the appended claims should be construed broadly, to include other variants and embodiments of the inventive concept, which may be made by those skilled in the art without departing from the scope and range of equivalents of the inventive concept.

What is claimed is:

1. A computer implemented method to process an event, the method comprising:
visually identifying, by an employee, an occurrence at the site;
entering data, by the employee, describing the occurrence on a portable computer;
electronically transmitting the data to an ERP application;
identifying a recipient of an alert based on business rules associated with the ERP application; and
transmitting the alert to the recipient.

2. The method as recited in claim 1, wherein the transmitting transmits the alert wirelessly to a portable device used by the recipient.

3. The method as recited in claim 1, wherein the transmitting transmit the alert to a desktop computer used by the recipient.

4. The method as recited in claim 3, wherein the desktop computer is running a mini-application that receives and displays the alert.

5. The method as recited in claim 4, further comprising allowing the recipient to indicate a response to the alert using the mini application.

6. The method as recited in claim 5, wherein the response is transmitted to the ERP application.

7. The method as recited in claim 1, wherein the data comprises an image drawn by the employee.

8. The method as recited in claim 1, further comprising automatically generating a ticket for the occurrence.

9. The method as recited in claim 1, wherein data is entered by the employee by handwriting words on the portable computer which is then automatically recognized by the portable computer.

10. A computer implemented method to interface with an ERP system, the method comprising:
providing form data for a form by a plant worker on a portable computer;
transmitting the form from the portable computer to an ERP system;
generating, by the ERP system, a ticket based on form data; and
transmitting ticket data relating to the ticket to the plant worker.

11. The method as recited in claim 10, wherein the form is stored both as an image as well as in the ERP as data.

12. The method as recited in claim 10, wherein ticket data is uploaded to a web page which servers the ticket data to requesters.

13. The method as recited in claim 12, wherein when a status of the ticket changes, the web page is automatically updated.

14. The method as recited in claim 10, wherein a first recipient of a desktop notification is identified using rules stored by the ERP system.

15. The method as recited in claim 14, wherein the first recipient is sent the desktop notification about the ticket using a mini-application running on the first recipient's desktop.

16. The method as recited in claim 15, wherein a second recipient of a wireless notification is identified using rules stored by the ERP system, the second recipient being different than the first recipient.

17. The method as recited in claim 16, wherein the second recipient is sent the wireless notification to the second recipient's cell phone or PDA.

18. The method as recited in claim 10, wherein the ERP system is running an SAP application.

19. A system to implement automatic notifications, the system comprising:
a server to receive form data from a portable computer;
an ERP application to receive the form data from the server and to generate a ticket request in the ERP application, wherein ticket data related to the ticket request is transmitted to the server, wherein the ticket data is transmitted to the portable computer.

20. The system as recited in claim 19, wherein the ERP application is an SAP application.

21. The system as recited in claim 19, further comprising a web serving application to generate and make available a web page containing the ticket data.

22. The system as recited in claim 21, wherein the ticket data is transmitted to the portable computer by the portable computer visiting the web page, wherein the portable computer displays the web page.
